(19) United States
(12) Patent Application Publication
(10) Pub. No.: US 2004/0030987 A1
(43) Pub. Date: Feb. 12, 2004

(54) Method for generating customized patient education documents

(76) Inventor: Donald D. Manelli, Chicago, IL (US)

Correspondence Address: Donald D. Manelli, Suite 200, 1 East Delaware Street, Chicago, IL, 60611, US

(21) Appl. No.: 10/427,109

(22) Filed: Apr. 30, 2003

Related U.S. Application Data
(60) Provisional application No. 60/376,193, filed on Apr. 30, 2002.

(51) Int. Cl. G06F 17/00

(52) U.S. Cl. 715/500

(57) ABSTRACT

A computer-assisted method and system for generating customized patient education documents on site and on demand at a medical or other health care practice. Said method eliminates the cost of purchasing educational materials, the need for physical storage of printed materials and the staff time required to order, store and maintain an inventory of educational materials. The method allows users to generate educational materials in languages other than English to respond to the educational needs of patients without fluency in English. The method allows users to customize printed documents with patient name and practice identity. The method allows users to edit, revise or create new documents which can be stored, customized and retrieved as part of the system. The method automatically prints out an informed consent document after all selected patient documents have been printed, showing patient name, date, and the list of documents provided to the patient.

### CROSS-REFERENCE TO RELATED APPLICATIONS

This application claims the benefits of PPA Ser. No. 60/376,193, filed Apr. 30, 2002 by the present inventor.

### FEDERALLY SPONSORED RESEARCH

Not Applicable

### SEQUENCE LISTING OR PROGRAM

Not Applicable

### BACKGROUND

1. Field of Invention

This invention relates to the patient education responsibility of professional health care practices.

2. Background of Invention

Patient education is a crucial component of care for medical practices and other health care providers. Helping patients understand their conditions and treatments enables physicians, clinicians, nurses, physical therapists, technicians and other professionals to enhance quality of care. Patient education, often in the form of printed documents or leaflets, can provide detailed information about relative risks and benefits to help patients make informed choices of available treatment options. Patient education can improve compliance with provider instructions by explaining treatment rationales and likely outcomes. Patient education helps surgical candidates prepare for procedures and observe post-procedure guidelines, provides information for self care, describes side effects and warning signs, teaches diet and lifestyle modifications, discusses management of long-term chronic conditions, gives family members and care givers the knowledge they need to provide better care and support. Patient education is an important constituent of almost all aspects of modern health care delivery.

However, patient education represents a major challenge for medical practices and other providers. It places time demands on practitioners and support staff already experiencing time and schedule constraints. More time is required to respond to phone calls from patients requesting clarification of care-related issues.

To minimize time demands while giving patients the information they need, providers often distribute educational literature and hand-outs. This also places a burden on the practice. Staff time is required to required to source, order, inventory and re-order this material. More time is required to retrieve appropriate documents in response to a patient need. If literature is purchased, it adds to practice operating costs. If free literature is accepted from drug companies and manufacturers, there is a risk of informational bias introduced by the commercial interests of the sponsor. From any source, pre-printed literature has a generic quality which does not seem an individualized response to a patient's educational needs and does not present a clear image of the practice itself.

There are other disadvantages. Physical space limitations can make it impractical to maintain a comprehensive library of educational materials. Practices may use medical procedures which vary from descriptions in the literature. A large Hispanic population with limited English language fluency may not be served by existing literature.

The importance of patient education is growing as new medical knowledge and alternatives emerge. At the same time, there is increasing pressure on practitioners to reduce cost, time, and the volume of paperwork.

Practices could generate their own patient education materials on demand to solve some of the problems associated with maintaining a library of educational materials identified above. Prior art discloses various computer-assisted systems which control different aspects of document generation but none offer the ease of use, the simple operator skills, the ability to be utilized by non-professional staff personnel, the speed in identifying and retrieving documents, and the minimal time investment in creating documents that would allow them to effectively replace traditional methods of storing and distributing a full range of patient education materials.

U.S. Pat. No. 5,148,366 to Buchanan et al. (1992) and U.S. Pat. No. 5,267,155 to Buchanan et al. (1993) describe computer-assisted document generation systems which allow a user to combine “boiler plate” with user-definable phrases in an existing template. The method taught is intended “for enhancing or replacing the process of dictating and transcribing.” However, due to the time constraints of a practice, this method requires too much user time to be practical for routine patient education. Indeed, the method described might take as much or more time than a personal meeting with the patient, adding to rather than easing the time burden. Also, the required user computer skill level and the necessity of professionally qualified content decisions negate its usefulness in this application, where minimal computer skills, short “transaction time” for retrieving and printing documents, and ability of non-professional clerical personnel to identify and deliver content to the patient are essential to the time and operational demands of a practice.

U.S. Pat. No. 6,014,630 to Jeacock, et al. (2000) describes a system for providing patient education but limits it to procedure-specific reports. The described system links data bases containing medical procedures, facility variances in practice and physician variances in practice in providing procedure in question. The system is intended to draw from these sources to produce a document describing the procedure as it will actually be performed. This method requires computing resources and networked databases which may not be available to many practices. It also requires professionally qualified input and computer expertise that do not meet the need for simplicity, speed and minimal computer user skills. It is also limited to medical procedures, which are a small part of the broad patient education spectrum.

U.S. Pat. No. 6,182,095 to Leymaster, et al. (2001), U.S. Pat. No. 6,249,809 to Bro (2001), and U.S. Pat. No. 5,277,188 to Selker (1994), also require a degree of interactivity and professional knowledge which do not provide the simplicity, speed and minimal computer skills necessary to meet the operational demands of a busy practice.

### OBJECTS AND ADVANTAGES

Accordingly, in addition to the objects and advantages indicated above, the objects and advantages of my invention are:

(a) to provide a broad and comprehensive library of medical peer-approved patient education literature covering all aspects of health care important to the educational responsibility of a practice;

(b) to allow individual documents to be retrieved and printed on demand and on site at a practice, eliminating the need for document storage space and inventory;

(c) to make individual and multiple documents easily retrievable and printable with a minimum of operator time;

(d) to make individual and multiple documents retrievable and printable with a minimum of operator skill;

(e) to provide a method and system that fits easily into established practice routines;

(f) to provide a method and system that allows quick and easy installation;

(g) to provide a method and system that can be installed and used on a practice's existing computer and printer systems on Windows or Macintosh operating systems.

(h) to allow individual documents to be customized with practice-preferred content;

(i) to allow new documents to be created by the practice and added to the system while retaining all of the systems's retrievability and printing features;

(j) to allow individual documents to be personalized with patient name to promote readership and compliance;

(k) to allow individual documents to be customized with the practice name, address, and other information to enhance practice image;

(l) to allow all documents to be provided in Spanish or other languages with a simple selection process;

(m) to provide an automatic “informed consent” function which prints a dated record of all documents received by individual patients, to be placed in patient files as an aid to defense in the eventuality of a malpractice suit.

Further objects and advantages are to provide a system for updating document content whereby new documents reflecting medical advances, treatment and procedures can be easily incorporated and to allow frequently recalled documents to be grouped, named and recalled with a single click of a computer mouse button. Still further objects and advantages will become apparent from a consideration of the ensuing description.

### SUMMARY

In accordance with the present invention, a method is provided whereby medical practices and other health care providers can easily and quickly generate patient education materials on site, on demand, in response to individual patient need, incorporating text and graphic elements and customized with patient and practice name.

### DRAWINGS—FIGURES

FIG. 1 shows a basic configuration of the method for generating patient education documents, utilizing existing computer equipment at a practice.

FIGS. 2 through 7 represent the various computer monitor display screens and controls that allow the computer user to operate the system.

FIG. 8 shows a flow chart of the method, from initiation of the process to delivery of the completed patient education document.

### DETAILED DESCRIPTION

### Preferred Embodiment

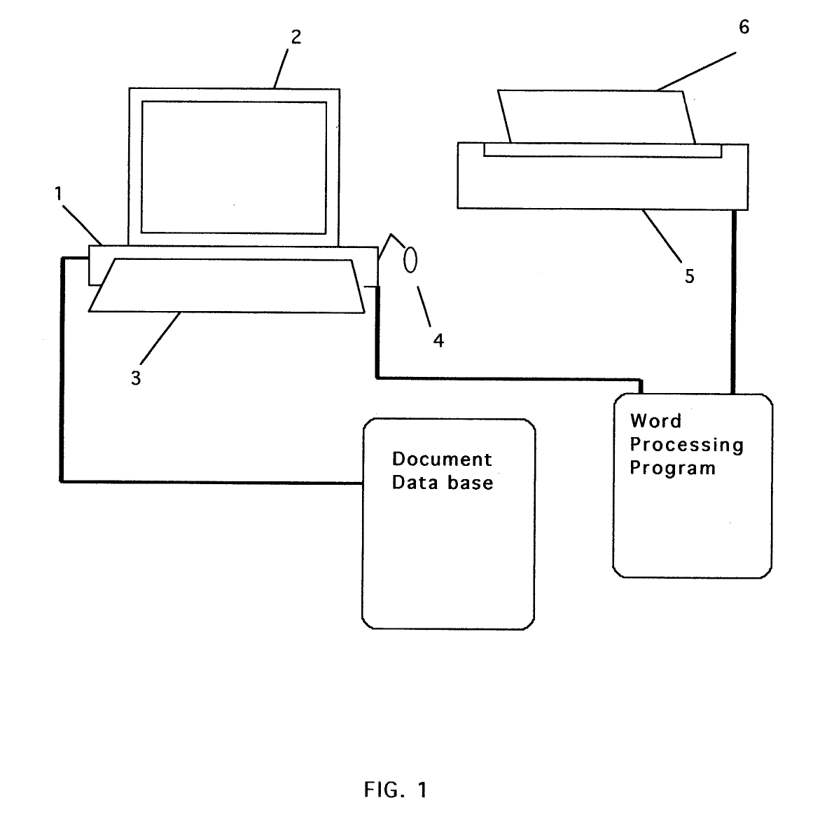

A preferred embodiment of the method is illustrated in FIG. 1. It consists of an existing desktop computer 1 which may be a computer running the Windows operating system or a computer running the Macintosh operation system, a monitor 2 and a keyboard 3 and a computer mouse 4 as input devices. A laser or inkjet printer 5 connected to the computer prints patient education documents 6 on operator demand. A data base of patient education documents is stored on optical or magnetic media or on an Internet web site and is downloaded into the computer 1 where it is stored. The documents combine text and graphic elements with “holes” which receive text entered by the operator, as described below. The data base also includes a software program which allows operators to access, navigate and edit the stored documents which appear on the computer monitor, select them and print them as described below.

For formatting, text entry, editing, typesetting and printing, the program uses an integrated word processing program, Microsoft Word, installed on the computer. Depending on printer capabilities, documents may be printed in black and white or in color.

The computer and peripheral equipment described above may be located anywhere there is appropriate computer equipment in a practice. A plurality of computers and monitors within a practice may contain the database and software program of the method, in examining rooms and doctors offices, for example. Printers may be located anywhere on the practice computer network. A location at the reception/checkout area of the practice allows patients to receive appropriate literature at the conclusion of their visit. Forms, health histories, questionnaires and other materials can also be printed out at this location for patients during the check in process, to be filled out before the visit with a physician or other practitioner.

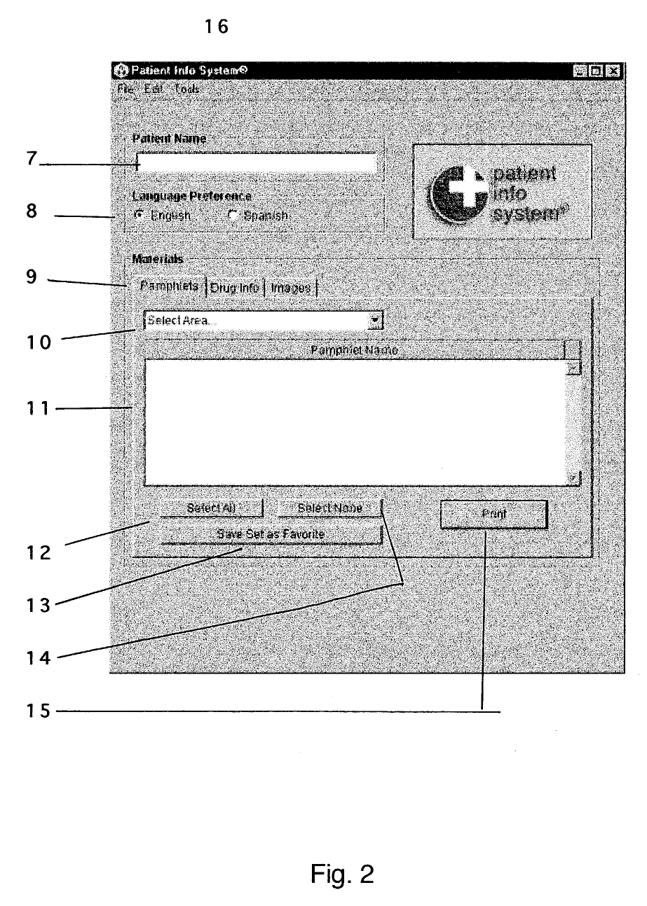

FIGS. 2 through 8 represent the screens that control the process of retrieval, customizing, selection and printing. When the data base and program is loaded into a practice's computer, a small icon resides on the computer screen. Clicking on this icon (using the mouse to place the cursor arrow on the icon and clicking the mouse button) opens the program home screen, FIG. 2.

The home screen contains a box for text entry of a patient name 7, and buttons 8 for the selection of English or Spanish language documents English is the default language. All system menus and displays remain in English when Spanish is selected, but documents print in Spanish.

A “materials” window contains tabs 9 at the top. Three tabs are shown but the method permits more to be added. Tabs may be named as appropriate for the medical specialty. This example shows “pamphlets” where patient information documents on diseases, conditions, treatment protocols, and other information are stored, along with a variety of forms and questionnaires useful in practice operation. “Drug info” stores patient information on prescribed drug uses, side effects Sand other information. “Images” stores a data base of medical art which may be used to help patients and staff visualize particular conditions or procedures. Selecting a tab displays navigation windows 10 and 11, and action/control buttons 12, 13, 14, 15.

A menu bar 16 remains at the top of all screens to assist in program operation and editing.

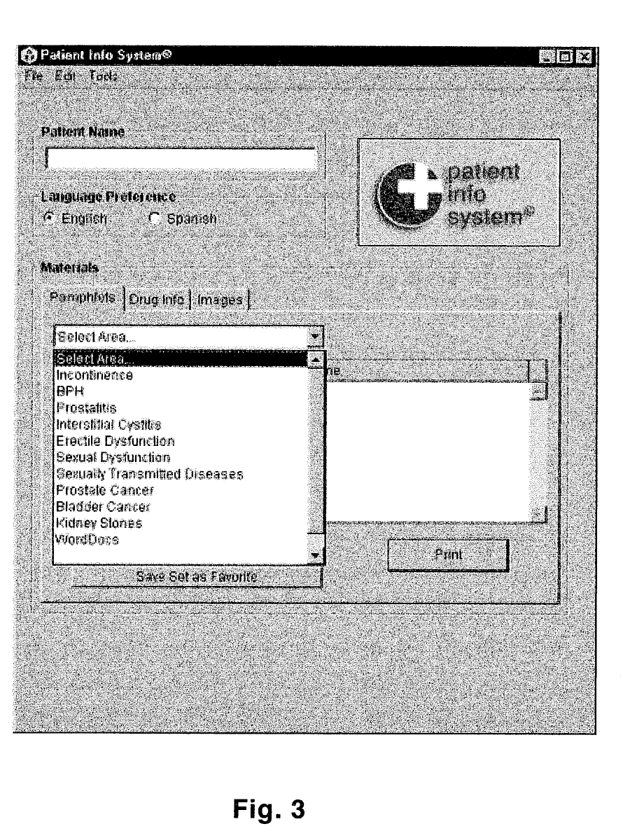

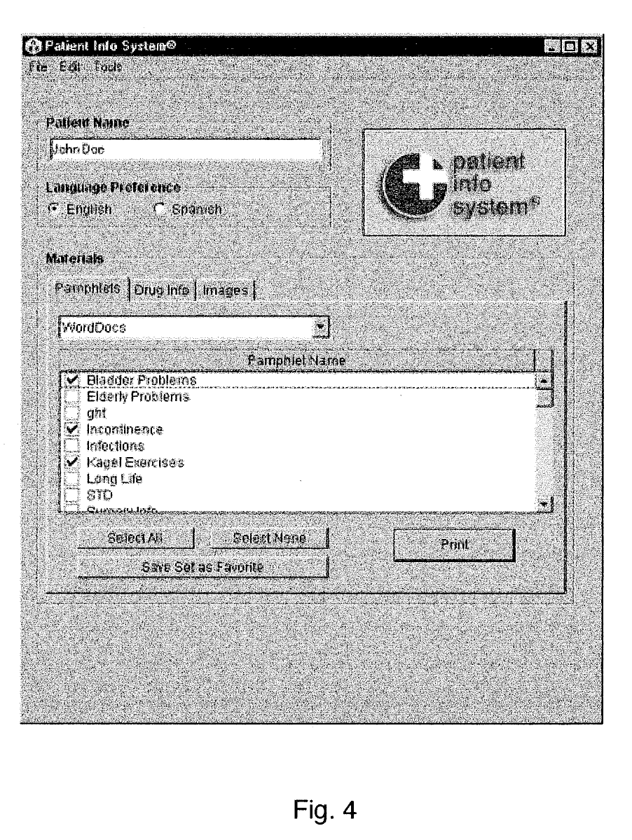

Clicking on “select area” scrolls down a list of categories, in this example, for a urological practice as shown in FIG. 3. In one continuous action, an operator clicks on the “select area” bar with the mouse button, scrolls down the displayed list of categories and releases the button on the appropriate category, causing the display in FIG. 4 to appear.

FIG. 4 shows “WordDocs” selected from the scrolled list in FIG. 3, which causes a scrollable list of individual patient education pamphlets, with check boxes next to them, to be displayed. The operator chooses the desired documents by clicking on the check box with the computer mouse. When the operator selects the “print” button 15, the documents print out on a laser or inkjet printer.

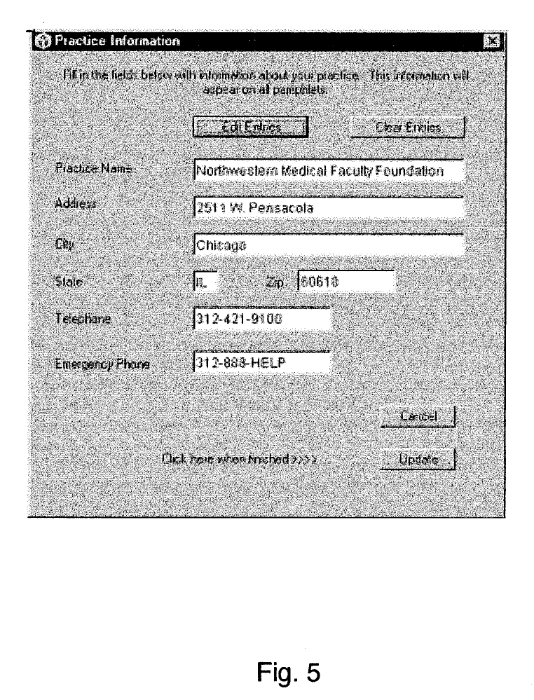

All documents print with the patient name, entered with the computer keyboard at the beginning of the process, and with the practice name, address and other information, which is entered once on a separate screen, FIG. 5, when the program is first installed, as described in the operating sequence below.

Clicking on the “Save Set as Favorite” button groups all selected documents (check boxes checked) under a name the user enters. A “Favorites” entry will then appear at the bottom of the scrollable list of patient education documents (FIG. 4). Clicking the check box before “Favorites” will take the user to a separate screen where all favorite groups selected and named by the user are displayed. The user selects the desired group, and all of the documents that group will then be printed, customized with patient and practice name as before. Thus, the process of selecting individual documents is made even simpler when identical packets of documents are routinely given out to patients—for example, an orientation packet, or in the case of a urological practice, a packet explaining the anatomy, causes and treatments of urinary incontinence.

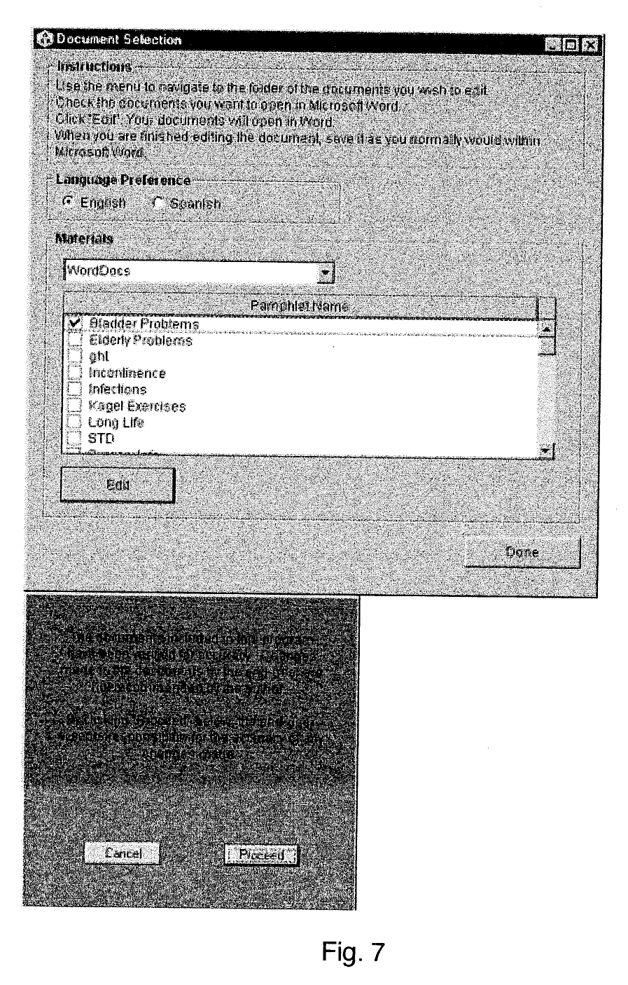

Physicians and other users of this system can call up any of the documents in the database, FIG. 7, and edit or revise their content. A warning screen displays reminding them that the documents as written have been verified for accuracy with specialists in the profession. The editing mode can also be used to create and name entirely new documents which will then appear in the appropriate scrollable menus. The system allows a plurality of these new documents to be created. New documents will retain the customization features of the program (patient and practice name will appear on the printed document).

### Operation

The sequence of steps for employing this method of generating customized patient education documents follows. The steps are divided into three sequences: sequence one is the installation of the system, sequence two is the routine implementation of the system, and sequence three is the use of the f“favorite” feature.

Stage One—Installation of the System

1/A The user places the system CD-Rom in the appropriate drive of the computer and clicks on the program installation icon displayed on the screen. The program installs itself automatically.

1/B. A screen, FIG. 5, appears and the user enters the appropriate practice information and clicks the “update” button. Practice information is now recorded in the program and will automatically appear on printed documents. If users wish to revise this information in the future, they can return to this screen make any necessary revisions, dick on the “update” button and the new information will replace the old.

1/C. If users wish to edit the content of any documents, or create new documents to place in the system, they can call up the screen in FIG. 7 by clicking on the “Edit” button in the top menu bar. Edited documents and/or newly created documents will then become permanent parts of the system unless and until they are deleted or further revised.

Stage Two—Routine use of the System.

2/A. A small icon remains on the computer screen once the system is installed. By clicking on this icon, the user calls up the home screen which he or she wishes to access the system.

2/B. The user types in the patient name 7 using the computer keyboard.

2/C The user selects a language 8, English being the default.

2/D The user clicks on a category tab 9.

2/E The user clicks on the “select” button 10 to display a scrollable list of information areas FIG. 3, and scrolls down the list, releasing the mouse button to select an area.

2/F A list of pamphlets displays FIG. 4. The user checks the boxes next to each pamphlet to be selected by locating the cursor in the box and clicking the mouse button.

2/G. If desired, the user repeats steps 4, 5, and 6 to select documents in other categories or information areas.

2/H The user clicks on the “print” button 15 and all selected documents print out, with the patient name and the practice information incorporated into the graphic design.

2/I At the conclusion of printing, an “informed consent” form prints out automatically. This is comprised of the patient's name, the date, and a listing of all documents given to the patient. A signature line is included for an optional patient signature. The form is retained by the practice, placed in the patient file.

Stage Three—Use of the “Favorite” Feature

Other aspects of this method increase its usefulness to a practice. If groups of documents are or will be routinely assembled for patients, for example, an orientation package or a procedure package or a medical condition package, the operator can call all of those documents up without the need to click on them individually. The operator selects the documents as indicated above, but rather than click on the “print” button 15, the operator clicks on the “save set as favorite” button 13 and will be prompted to name the favorite.

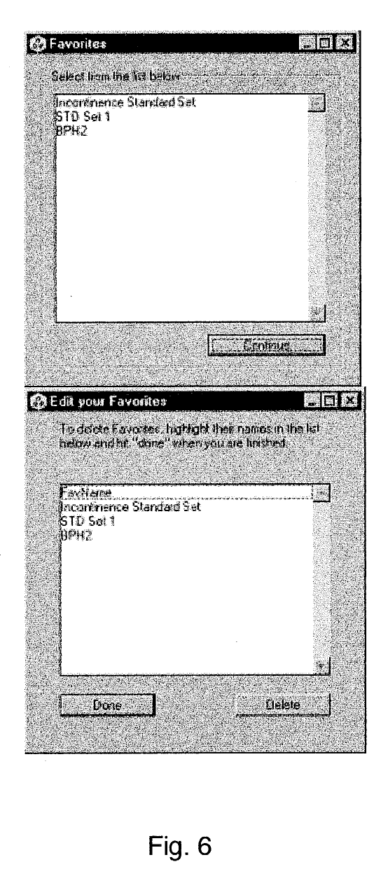

Following this process, as the user scrolls down the list of documents, he or she will come to an entry labeled “favorites”. Clicking on this entry will take the user to the “favorites” screens, FIG. 6. The top screen allows the user to select favorite group, then return to the home screen to issue the print command. The bottom screen allows the user to add or delete favorites sets in the future.

### CONCLUSION, RAMIFICATIONS AND SCOPE

This invention brings new benefits to patients, staff, and health care practices. Patients will benefit from expanded patient education made possible by the breadth and depth of educational documents stored and instantly retrievable by the system—a volume of material that would be very difficult and costly for most practices to inventory, index and maintain. Patients also benefit by the high quality of care that this method for generating education documents engenders. It makes information more readily available, so that patients can gain deeper understanding of their conditions, available treatments and procedures, and other health care issues impacting their lives.

For practice staff, this method greatly reduces the work load associated with a paper based educational system, eliminates office clutter, and allows them to meet their patient education responsibilities with minimum demands on their time.

The practice itself benefits by eliminating operating expenses associated with purchasing and maintaining a library of patient literature, enhances their professional image by expanding their patient education capability, builds patient loyalty by offering personalized information.

In addition, the method allows practices to customize all material to their own individual preferences and revise the content of provided material as needed.

I claim:

1. A method of generating patient educational materials for medical and other health care practices, comprising:
(a) a database of educational documents combining text and graphic elements,
(b) an input means which allows users personalize said documents with patient name and practice identity,
(c) a display system which allows the operator to easily locate and select each desired document,
(d) an input means which allows users to edit existing documents and create new documents which will then be displayed and retrievable in the same way as other documents in the system,
(e) a method for printing all selected documents that will place patient name and practice identity into each document as part of the graphic design
(f) a method which allows said database and retrieval system to operate on both the Windows and Macintosh operating systems
(g) a method whereby an informed consent document is automatically printed after all selected documents are printed out, consisting of the patient name, date, and list of all documents printed for the patient.
(h) a method for controlling and navigating said system which minimizes operator time,
(i) a method for controlling and navigating said system which minimizes the required operator skill,
(j) a method for printing selected documents in languages other than English.
